(19) United States
(12) Patent Application Publication
(10) Pub. No.: US 2016/0264098 A1
(43) Pub. Date: Sep. 15, 2016

(54) Vehicle Security System

(71) Applicant: Waletta Joyce-Harris, Muncie, IN (US)

(72) Inventor: Waletta Joyce-Harris, Muncie, IN (US)

(21) Appl. No.: 14/656,922

(22) Filed: Mar. 13, 2015

(51) Int. Cl. B60R 25/30; G01S 19/13

(52) U.S. Cl. CPC B60R 25/305; G01S 19/13

(57) ABSTRACT

A vehicle security system includes a vehicle and a control unit positioned within the vehicle. An actuator is positioned within the vehicle and the actuator is in communication with the control unit such that the actuator is actuatable to turn the control unit on and off. A video recording unit is positioned within the vehicle and the video recording unit records a video of activity within the vehicle. The video recording unit is in communication with the control unit such that the control unit stores the video. A remote unit is in communication with the control unit such that the remote unit turns the control unit on and off.

### BACKGROUND OF THE DISCLOSURE

### Field of the Disclosure

The disclosure relates to security devices and more particularly pertains to a new security device for recording video and audio of activity within and around a vehicle while the vehicle is occupied.

### SUMMARY OF THE DISCLOSURE

An embodiment of the disclosure meets the needs presented above by generally comprising a vehicle and a control unit positioned on the vehicle. An actuator is positioned within the vehicle and the actuator is in communication with the control such that the actuator is actuatable to turn the control on and off. A video recording unit is positioned within the vehicle and the video recording unit records a video of activity within the vehicle. The video recording unit is in communication with the control such that the control stores the video. A remote unit is in communication with the control to remotely turn the control unit on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a kit view of a vehicle security system according to an embodiment of the disclosure.

FIG. 2 is a perspective in use view of an embodiment of the disclosure.

FIG. 3 is a perspective view of an embodiment of the disclosure.

FIG. 4 is a side perspective view of an embodiment of the disclosure.

FIG. 5 is a schematic view of an embodiment of the disclosure.

### DESCRIPTION OF THE PREFERRED EMBODIMENT

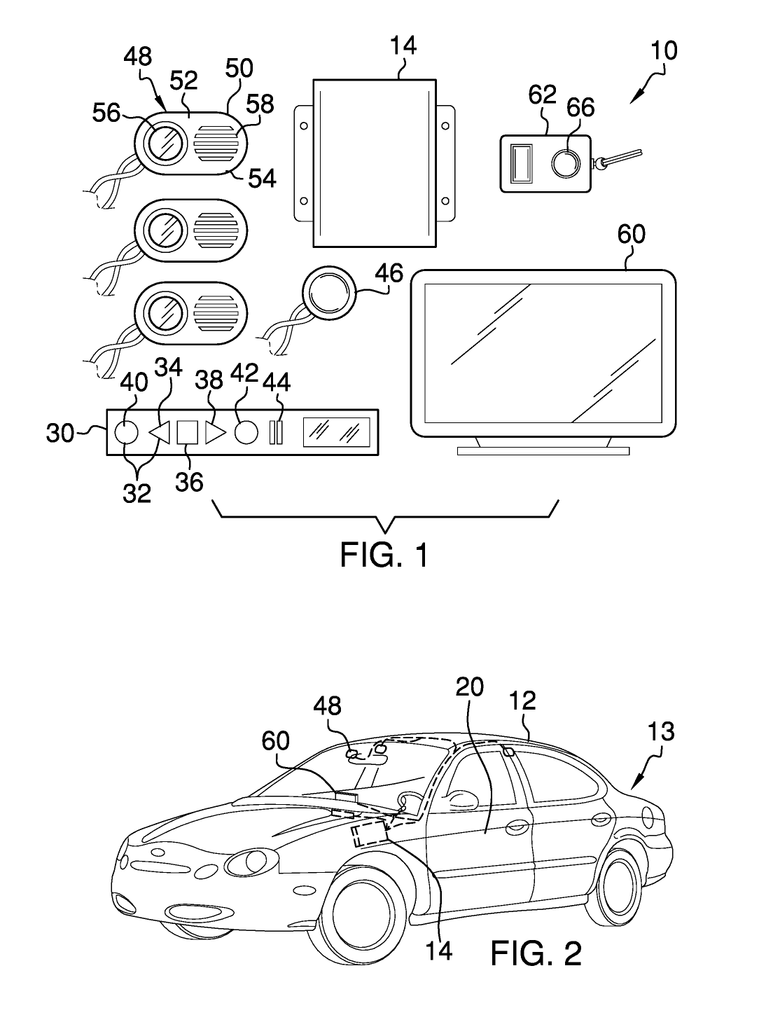

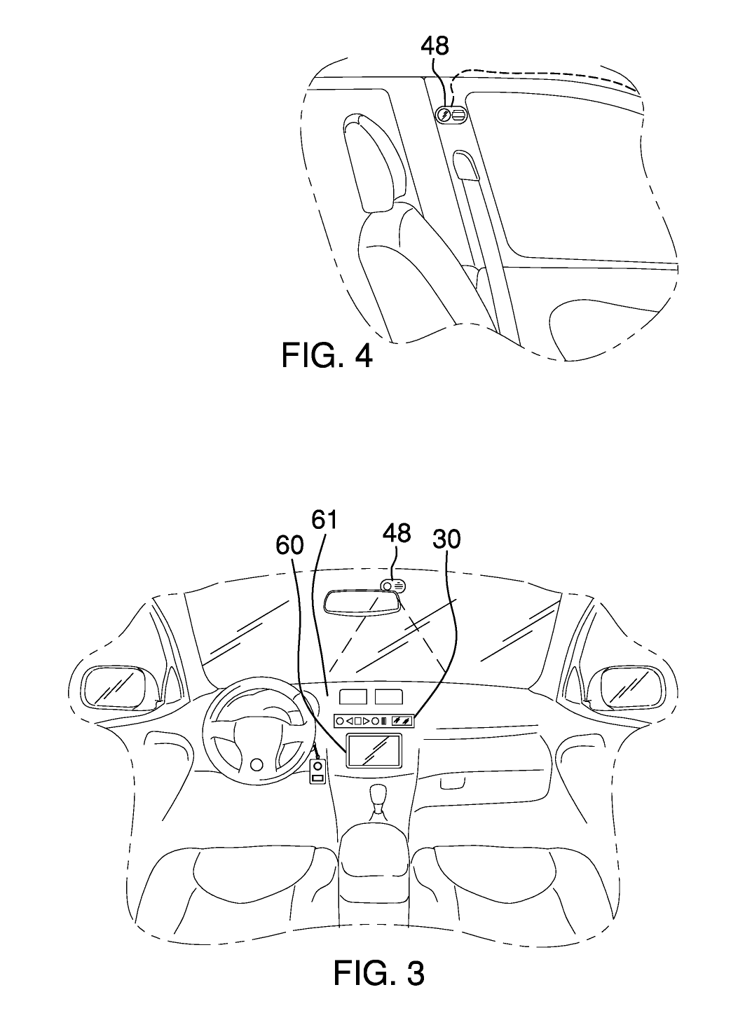

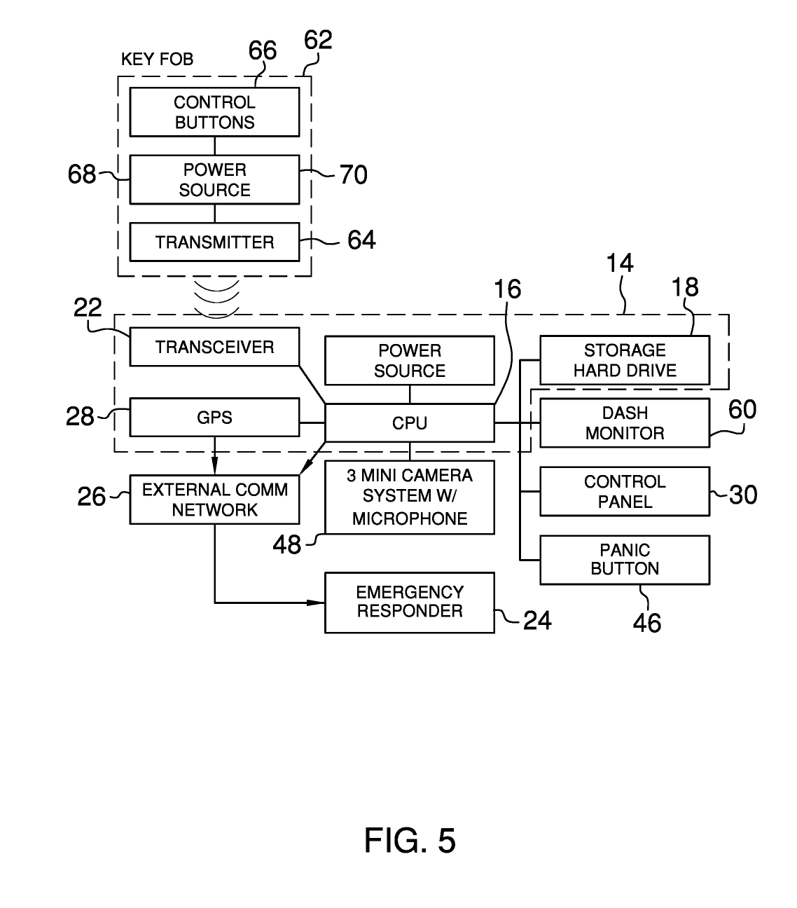

With reference now to the drawings, and in particular to FIGS. 1 through 5 thereof, a new security device embodying the principles and concepts of an embodiment of the disclosure and generally designated by the reference numeral 10 will be described.

As best illustrated in FIGS. 1 through 5, the vehicle security system 10 generally comprises a vehicle 12. The vehicle 12 may be a passenger vehicle or the like. A control unit 14 is positioned on the vehicle 12 and may be positioned in an area such as a trunk 13 of the vehicle 12 or the like to facilitate the control unit 14 to be concealed and difficult to access. The control unit 14 comprises a control circuit 16 that is electrically coupled to the vehicle 12 to detect when a door 20 of the vehicle 12 is opened or closed and when the vehicle 12 has been turned off. An electronic memory 18 is electrically coupled to the control circuit 16 and the electronic memory 18 may comprise any electronic memory storage device.

A transceiver 22 is electrically coupled to the control circuit 16 and the transceiver 22 is in electrical communication with an emergency responder 24 via an external communications network 26. The transceiver 22 may be a radio frequency transceiver or the like and the external communications network 26 may be a cellular phone network, the internet, OnStar or the like. The emergency responder 24 may be any emergency response organization such as law enforcement or the like. A global positioning system 28 is electrically coupled to the control circuit 16 and the global positioning system 28 indicates a physical location of the vehicle 12. The transceiver 22 communicates the physical location of the vehicle 12 to the emergency responder 24.

An actuator 30 is positioned in the vehicle 12 such that the actuator 30 is easily accessible. The actuator 30 is in communication with the control unit 14 such that the actuator 30 is actuatable to turn the control unit 14 on and off. The actuator 30 comprises one or more switches 32 that are each coupled to the actuator 30. Each of the switches 32 are electrically coupled to the control circuit 16 and each of the switches 32 are actuatable to control various functions of the control unit 14. The switches 32 may comprise a rewind switch 34, a play switch 36, a fast forward switch 38, a record switch 40, a stop switch 42 and a pause switch 44. The actuator 30 may additionally include a keyboard for inputting letters and numbers. The actuator 30 may also be used to enter a numerical code number into the control circuit 16.

A panic actuator 46 is positioned within the vehicle 12 such that the panic actuator 46 is easily accessible. The panic actuator 46 is electrically coupled to the control circuit 16 and the panic actuator 46 is actuatable such that the transceiver 22 notifies the emergency responder 24 of an emergency. A video recording unit 48 is positioned within the vehicle 12 and the video recording unit 48 records a video and audio of activity within the vehicle 12. The video recording unit 48 is in communication with the control unit 14 such that control unit 14 stores the video.

The video recording unit 48 comprises a housing 50 that has a front side 52 and a back side 54 and the back side 54 is coupled to the vehicle 12 such that the housing 50 is positioned within the interior of the vehicle 12. A camera 56 is coupled to the front side 52 such that the camera 56 is positioned to record the video of activity within the vehicle 12. The camera 56 is electrically coupled to the control circuit 16 such that the electronic memory 18 stores the video. The camera 56 may be an infra-red camera or the like.

A microphone 58 is coupled to the housing 50 such that the microphone 58 is positioned to record audio of the activity within the vehicle 12. The microphone 58 is electrically coupled to the control circuit 16 such that the electronic memory 18 stores the audio. The video recording unit 48 may be one of a plurality of video recording units 48 distributed within the vehicle 12 in order to surveil the entire vehicle 12 and the vehicle's 12 surroundings.

A monitor 60 is positioned within the vehicle 12 such that the monitor 60 is easily accessible. The monitor 60 may be positioned on a dashboard 61 of the vehicle 12. The monitor 60 is electrically coupled to the control circuit 16 and the monitor 60 displays the video stored within the electronic memory 18. The monitor 60 may comprise an LED display or the like.

A remote unit 62 is in communication with the control unit 14 for remotely turning the control unit 14 on and off. The remote unit 62 comprises a transmitter 64 that is in electrical communication with the transceiver 22. The transmitter 64 may comprise a radio frequency transmitter or the like. A remote actuator 66 is electrically coupled to the transmitter 64 and the remote actuator 66 is actuatable to turn the control unit 14 on and off. A power supply 68 is electrically coupled to the remote actuator 66 and the power supply 68 may comprise at least one battery 70. The remote unit 62 may be hand held or carried on a key ring or the like.

The control circuit 16 may be electrically coupled to the vehicle 12 through a solid conductor or the like in a vehicle 12 that was manufactured prior to model year 2015 or in a vehicle 12 that does not come from the factory with an integrated monitor. The control circuit 16 may be in wireless communication with the vehicle 12 if the vehicle 12 was manufactured after model year 2015 or if the vehicle 12 comes from the factory with an integrated monitor. The switches 32 may be integrated into the monitor 60 as a touch screen function in a vehicle 12 manufactured after model year 2015 or in a vehicle 12 that comes from the factory with the integrated monitor. The monitor 60 provided with the assembly is not utilized in the vehicle 12 that is manufactured after model year 2015 or in the vehicle 12 that has the integrated monitor.

In use, the video recording unit 48 begins recording the video and audio of the vehicle 12 after the control circuit 16 senses that the door 20 of the vehicle 12 has been closed and the vehicle 12 has been turned off. The video recording unit 48 continuously records the video and audio until the stop actuator 42 on the actuator 30 is actuated. The numerical code may be entered into the actuator 30 in order to delete the video and audio from the electronic memory 18. The panic actuator 46 is actuated if an emergency occurs while the vehicle 12 is occupied. The emergency responder 24 is notified of the emergency and the physical location of the vehicle 12 is communicated to the emergency responder 24. Additionally, the video recording unit 48 may be turned on and off with the remote unit 62. The video and audio may be used as evidence of a theft of the vehicle 12 or vandalism of the vehicle 12. The monitor 60 is utilized to view the video stored in the electronic memory 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle security system configured to provide closed circuit surveillance of the vehicle, said system comprising:
a vehicle;
a control unit positioned on said vehicle;
an actuator positioned within said vehicle, said actuator being in communication with said control unit such that said actuator is actuatable to turn said control unit on and off;
a camera being coupled to said vehicle, said camera being positioned to monitor activity within said vehicle, said camera being in a visible position within said vehicle;
a video recording unit positioned within said vehicle, said video recording unit being operationally coupled to said camera, said video recording unit recording a video of activity within said vehicle, said video recording unit being in communication with said control unit such that said control unit stores said video, wherein said video recording unit comprises a housing having a front side and a back side, said back side being coupled to said vehicle such that said housing is positioned within said interior of said vehicle, said camera being positioned on said front side of said housing; and
a remote unit being in communication with said control unit such that said remote unit remotely turns said control unit on and off.

2. The system according to claim 1, wherein said control unit comprises a control circuit being electrically coupled to said vehicle, an electronic memory being electrically coupled to said control circuit, a transceiver being electrically coupled to said control circuit, said transceiver being configured to be in electrical communication with an emergency responder via an external communications network, a global positioning system being electrically coupled to said control circuit, said global positioning system determining a physical location of said vehicle, said camera being electrically coupled to said control circuit such that said electronic memory stores said video.

3. The system according to claim 2, further comprising a plurality of switches each being coupled to said actuator, each of said switches being electrically coupled to said control circuit, each of said switches being actuatable to control functions of said control unit.

4. The system according to claim 3, further comprising a panic actuator being positioned within said vehicle, said panic actuator being electrically coupled to said control circuit, said panic actuator being configured to be actuatable such that said transceiver notifies the emergency responder of an emergency.

5. (canceled)

6. (canceled)

7. The system according to claim 1, further comprising a microphone being coupled to said front side such that said microphone is positioned to record audio of the activity within said interior of said vehicle, said microphone being electrically coupled to said control circuit such that said electronic memory stores said audio.

8. The system according to claim 2, further comprising a monitor being positioned within said vehicle, said monitor being electrically coupled to said control circuit, said monitor displaying said video stored within said electronic memory.

9. The system according to claim 2, wherein said remote unit comprises a transmitter being in electrical communication with said transceiver.

10. The system according to claim 9, further comprising a remote actuator being electrically coupled to said transmitter, said remote actuator being actuatable to remotely turn said control unit on and off, a power supply being electrically coupled to said remote actuator, said power supply comprising at least one battery.

11. A vehicle security system configured to provide closed circuit surveillance of the vehicle, said system comprising:
a vehicle;
a control unit positioned within said vehicle, said control unit comprising:
a control circuit being electrically coupled to said vehicle;
an electronic memory being electrically coupled to said control circuit;
a transceiver being electrically coupled to said control circuit, said transceiver being configured to be in electrical communication with an emergency responder via an external communications network; and
a global positioning system being electrically coupled to said control circuit, said global positioning system determining a physical location of said vehicle;
an actuator positioned within said vehicle, said actuator being in communication with said control unit such that said actuator is actuatable to turn said control unit on and off;
a plurality of switches each being coupled to said actuator, each of said switches being electrically coupled to said control circuit, each of said switches being actuatable to control various functions of said control unit;
a panic actuator being positioned within said vehicle, said panic actuator being electrically coupled to said control circuit, said panic actuator being actuatable such that said transceiver notifies law enforcement of an emergency;
a video recording unit positioned within said vehicle, said video recording unit recording a video of activity within said vehicle, said recording being in communication with said control unit such that control unit stores said video, said video recording unit comprising:
a housing having a front side and a back side, said back side being coupled to said vehicle such that said housing is positioned within said interior of said vehicle;
a camera being coupled to said front side such that said camera is visible within said vehicle and positioned to record said video of activity within said vehicle, said camera being electrically coupled to said control circuit such that said electronic memory stores said video; and
a microphone being coupled to said front side such that said microphone is positioned to record audio of the activity within said vehicle, said microphone being electrically coupled to said control circuit such that said electronic memory stores said audio;
a monitor being positioned within said vehicle, said monitor being electrically coupled to said control circuit, said monitor displaying said video stored within said electronic memory; and
a remote unit being in communication with said control unit such that said remote unit remotely turns said control unit on and off, said remote unit comprising:
a transmitter being in electrical communication with said transceiver;
a remote actuator being electrically coupled to said transmitter, said remote actuator being actuatable to turn said control on and off; and
a power supply power supply being electrically coupled to said remote actuator, said power supply comprising at least one battery.
